(19) United States
(12) Patent Application Publication
(10) Pub. No.: US 2017/0029631 A1
(43) Pub. Date: Feb. 2, 2017

(54) AQUEOUS FLAME RETARDANT COMPOSITION FOR MINERAL FIBER-BASED MAT, AND MATS OBTAINED

(71) Applicant: SAINT-GOBAIN ADFORS, Chambery (FR)

(72) Inventor: Nadege OMBE WANDJI, Maisons Alfort (FR)

(73) Assignee: SAINT-GOBAIN ADFORS, Chambery (FR)

(21) Appl. No.: 15/291,778

(22) Filed: Oct. 12, 2016

Related U.S. Application Data
(63) Continuation of application No. 13/885,081, filed on May 13, 2013, now abandoned.

(30) Foreign Application Priority Data
Nov. 26, 2010 (FR) 10 59781

(51) Int. Cl. C09D 5/18; C03C 25/10; C03C 25/32; D06M 15/263; C09K 21/02; D06M 11/44; D06M 11/45; D06M 15/564; C03C 25/44; C03C 25/28

(52) U.S. Cl. CPC C09D 5/18; C03C 25/44; C03C 25/1095; C03C 25/326; C03C 25/285; C09K 21/02; D06M 11/44; D06M 11/45; D06M 15/564; D06M 15/263; D06M 2200/30

(57) ABSTRACT

The present invention concerns an aqueous flame retardant composition for mineral fiber-based mats, in particular glass or rock fibers, which comprises:
at least one thermoplastic or thermoset resin;
magnesium hydroxide, Mg(OH)₂, and aluminum hydroxide, AlOOH, as flame retarding agents; and
optionally, carbon black.

It also concerns mats treated with said flame retardant composition.

The present invention relates to the field of mineral fiber-based mats provided with flame retarding properties.

More particularly, it relates to an aqueous flame retardant composition that contains a thermoplastic or thermoset resin and specific flame retarding agents, and mats obtained thereby.

Mats based on non-woven mineral fibers (also known as “nonwovens”, “non-wovens” or “veils”) are well known and used in many applications, in particular as a surface coating for various materials, in particular thermal insulation and/or acoustic insulation products based on mineral wool.

Such mats can be manufactured using conventional processes operated using “dry” or “wet” procedures.

In the dry procedure, molten mineral matter contained in a furnace is routed to an assembly of dies from which filaments flow under gravity and are stretched by a gaseous fluid. The mineral filaments are harvested on a conveyer where they become entangled, forming a mat.

An aqueous binder composition is applied to the upper face of the mat thus formed using suitable equipment, usually by curtain coating, and the excess binder is eliminated by suction from the opposite face. The mat then enters equipment containing hot air wherein the temperature (of the order of 180° C. to 260° C.) and the time period (at most 5 minutes) are such as to eliminate water and cure the binder; the mineral fiber mat is then collected in the form of a roll.

In the wet procedure, the mat is obtained from an aqueous dispersion of cut mineral fibers that is deposited by means of a forming head onto a conveyor provided with perforations; water is extracted through the conveyor by means of a suction box. The cut mineral fibers remaining on the conveyor form a mat that is treated under conditions that are the same as those described for the dry procedure.

In the procedures mentioned above, the binder composition acts to bind the mineral fibers together and to provide the mat containing them with mechanical properties that are suitable for the desired usage, in particular sufficient rigidity to be able to be handled easily, in particular without running the risk of being torn.

The binder composition to be applied to the mineral fibers is generally in the form of an emulsion or an aqueous dispersion containing at least one thermoplastic and/or thermoset resin and additives such as a resin curing catalyst, an adhesion-promoting silane, a flame retardant, etc.

The most widely used thermoplastic resins are resins based on polyvinyl acetate, styrene-butadiene (SBR) and acrylic polymers. The thermoset resins include resins based on formaldehyde, in particular phenolics belonging to the resol family, urea-formaldehyde resins and melamine-formaldehyde resins.

One disadvantage of such resins lies in their ready tendency to be consumed in the event of fire when the mineral fiber-based mats are exposed directly to flames.

One well-known method for improving the fire resistance of said mats consists of including in them flame retardant agents such as halogenated compounds, in particular based on bromine or chlorine, or phosphorus-containing compounds. It is also known to use metallic hydroxides; they have the advantage of being less expensive than the preceding flame retardant agents.

Thus, US 2005/0208852 describes a fibrous mat for a bituminous roofing membrane with fibers that are bonded by a flame retardant composition that contains a polymeric binder and an aluminum hydroxide.

EP 2 053 083 A1 proposes a flame retardant composition for fibrous mats that contains at least one organic binder and at least one filler, preferably selected from the following group of compounds: calcium carbonate, mica, clay, aluminum trihydroxide and talc.

U.S. Pat. No. 7,608,550 describes a fibrous mat to cover ventilation duct panels or acoustic and/or thermal insulation panels based on mineral wool. The fibrous mat is based on glass fibers bonded with a composition containing an organic binder and, as flame retardant agents, a metallic hydroxide and carbon black. The preferred metallic hydroxide is magnesium hydroxide or aluminum trihydroxide.

The aim of the present invention is to provide an aqueous flame retardant composition that provides the glass fiber-based mats to which it is applied with improved fire resistance properties.

The aqueous flame retardant composition of the present invention is characterized in that it comprises:
at least one thermoplastic or thermoset resin;
magnesium hydroxide, Mg(OH)₂, and aluminum hydroxide, AlOOH, as flame retarding agents; and
optionally, carbon black.

The thermoplastic or thermoset resin of the present invention may be a styrene-butadiene (SBR), ethylene-vinyl chloride, polyvinylidene chloride, which may or may not be modified, polyvinyl alcohol, ethylene-vinyl acetate (EVA), polyvinyl acetate, ethyl acrylate-methyl methacrylate, non-carboxylic acrylic-acrylonitrile, carboxylic butyl acrylate, polyvinylidene chloride-acrylic acid, methyl methacrylate-styrene, acrylic acid-styrene, or polyacrylic acid resin, or a urea-formaldehyde, melamine-formaldehyde resin or phenol-formaldehyde resin. Acrylic resins, urea-formaldehyde resins and mixtures of these resins are preferred.

The quantity by weight of resin in the aqueous flame retardant composition represents 20% to 95% of the total weight of the thermoset resin, Mg(OH)₂ and AlOOH, preferably 40% to 95%.

The association of flame retardant agents Mg(OH)₂ and AlOOH exhibits a synergistic effect that results in better fire resistance properties.

In the aqueous flame retardant composition, the quantity by weight of Mg(OH)₂ and AlOOH represents 5% to 80% of the total weight of the thermoset resin, Mg(OH)₂ and AlOOH, preferably 5% to 60%.

The Mg(OH)₂:AlOOH weight ratio is generally in the range 0.3:0.7 to 0.7:0.3, preferably in the range 0.4:0.6 to 0.7:0.3 and advantageously equal to 0.5:0.5.

The aqueous flame retardant composition may also comprise at least one mineral filler, for example calcium carbonate, a clay, talc or mica. Calcium carbonate is preferred since it has been observed to contribute to improving the fire resistance properties.

The quantity of fillers in the aqueous flame retardant composition may represent up to 30% of the total weight of the thermoset resin, Mg(OH)₂ and AlOOH, preferably up to 25% and advantageously up to 22%.

As already mentioned, the aqueous flame retardant composition may comprise carbon black, which means that colored flame retardant mineral fiber-based mats can be produced.

In this case, the quantity of carbon black represents 10% to 30% of the total weight of the thermoset resin, Mg(OH)₂ and AlOOH, preferably 15% to 30% and advantageously 20% to 28%.

The aqueous flame retardant composition of the invention may also comprise the following conventional additives: organic and/or inorganic pigments, surfactants, rheology-modifying agents, antifoaming agents, biocides, stabilizers, in particular thermal oxidation retardants, thickeners and water repellent agents.

The total quantity of the additives cited above does not exceed 5% of the total weight of the thermoset resin, Mg(OH)₂ and AlOOH, preferably 2%.

The aqueous flame retardant composition of the present invention is intended to be applied to non-woven fiber mats comprising mineral fibers; said mats constitute a further aspect of the invention.

In a first, preferred, embodiment, the aqueous flame retardant composition is deposited on the mineral fiber-based mat (formed using the dry procedure or the wet procedure), then the mat is treated at a temperature that allows curing of the thermoset resin, which then becomes infusible. Curing is carried out at a temperature that is generally in the range 150° C. to 260° C., preferably in the range 180° C. to 220° C., and for a period of at most 3 minutes, preferably 10 seconds to 1 minute, and advantageously 15 to 30 seconds. The mat is then collected up in the form of a roll.

In a second embodiment, the aqueous flame retardant composition is deposited on the mineral fiber-based mat bonded by the binder composition in a supplemental step after collecting up the mat.

The aqueous flame retardant composition is applied to the unrolled mat under the conditions used for applying the binder composition described in the first embodiment. The excess aqueous flame retardant composition is eliminated by suction; the mat then undergoes a heat treatment under conditions identical to those discussed above for the first embodiment, then it is once more collected up in the form of a roll.

The mineral fibers are glass fibers, for example E, C, R or AR (alkali-resistant) glass, basalt or wollastonite (CaSiO₃), preferably glass fibers. Glass fibers are preferred, advantageously E glass.

The mineral fibers are generally in the form of filaments.

The mineral fiber mat is composed of discontinuous mineral filaments with a length that can be up to 150 mm, preferably in the range 20 to 100 mm and advantageously in the range 50 to 70 mm, and with a diameter that may vary widely, for example from 5 to 30 μm.

Glass fibers may also be in the form of threads composed of a multitude of filaments (or base threads) that are bonded together by a size or into the form of assemblies of such threads into rovings.

The threads cited above may be untwisted threads or twisted (textile) threads, preferably untwisted.

The glass threads are generally cut to a length that may be up to 100 mm, preferably in the range 6 to 30 mm, advantageously 8 to 20 mm and more preferably 10 to 18 mm. The diameter of the glass filaments constituting the threads may vary widely, for example from 5 to 30 μm. In the same manner, large variations may arise in the linear density of the thread, which may be from 34 to 1500 tex.

The mineral fiber mat may comprise synthetic or natural organic fibers, preferably synthetic.

Examples of synthetic fibers that may be cited are fibers based on an olefin such as polyethylene or polypropylene, a polyester such as an alkylene polyterephthalate, especially ethylene polyterephthalate, or a polyamide (nylon). Polyethylene fibers are preferred.

Examples of natural fibers that may be cited are vegetable fibers, especially cotton, coconut, sisal, hemp or linen, and animal fibers, in particular silk or wool.

If necessary, the mat may be reinforced with continuous fibers that are generally deposited on the mat conveying device in the direction of advance of the mat and distributed over all or a portion of the width of the mat. These fibers are generally deposited in the thickness of the mat of fibers, in particular mineral fibers, before applying the binder composition.

The reinforcing fibers may be mineral and/or organic fibers of the same chemical nature as the fibers cited above constituting the mat of fibers of the invention.

Glass reinforcing fibers are preferred.

As a general rule, the fibers that form part of the constitution of the mat in accordance with the invention are constituted by more than 50% by weight of mineral fibers, preferably more than 75% and advantageously 100%. Particularly preferably, the fibers are formed from glass.

The mineral fiber-based mat generally has a mass per unit area in the range 10 to 1100 g/m², preferably in the range 30 to 350 g/m², advantageously in the range 35 to 75 g/m².

The flame retardant composition generally represents 7% to 30% of the weight of the mineral fiber mat, preferably 10% to 25%, calculated on the basis of the solid materials.

The flame retardant mineral fiber mat of the present invention may be used in numerous applications, for example as a coating, which may or may not be for painting, for application to walls and/or ceilings, as a surface coating or for joining plaster or cement panels, as a surface coating for thermal and/or phonic insulation products such as mineral wool or a foam, more particularly for the insulation of roofs, as a membrane for sealing roofs, in particular shingles, or to produce a floor covering, in particular an acoustic sub-layer.

Preferably, the flame retardant mat is intended for use as a surface coating for mineral wool-based insulation products.

The following examples serve to illustrate the invention without, however, limiting its scope in any way.

In these examples, the following were measured for the flame retardant mat:
the flame propagation distance, expressed in mm, in accordance with ISO standard 11925-2 (class B);
the superior calorific value (SOP) in accordance with ISO standard 1716, expressed in MJ/kg of mat. The superior calorific value corresponds to the maximum theoretical release of heat during combustion;
the presence of residues after exposure to high temperatures. The flame retardant mat undergoes the following fogging test: a sample (75 mm×75 mm) is deposited on a hotplate, an aluminum cylindrical tube is disposed around the sample and an alkali-resistant glass plate is placed on the top of the tube. The sample is heated to 220° C. for 150 hours.

The cooled glass plate is examined visually in order to detect the presence of condensed deposits that result in fogging of the glass. The evaluation is made on a scale from V1 (no fogging) to V4 (significant fogging).

The transmittance of the glass of the plate in the visible region (wavelength 300 to 2500 nm) is also measured before and after the fogging test. The samples are classified as a function of the difference (ΔT) of said transmittances as follows:

| ΔT | Classification |
|---|---|
| 0-0.003 | T1 |
| 0.003-0.010 | T2 |
| 0.010-0.015 | T3 |
| More than 0.015 | T4 |

Compositions in classes V4 and/or T4 are not acceptable.

### EXAMPLES 1 TO 7

Aqueous flame retardant compositions were prepared containing the constituents shown in Table 1 in proportions expressed as the % by weight, with the parts by weight being in parentheses. The various constituents were introduced into a vessel containing water at ambient temperature with moderate agitation until a uniform dispersion was obtained.

The solid matter content (dry extract) of the flame retardant compositions was equal to 13%.

A mat of E glass fibers was produced using the wet procedure, operating the process in accordance with the first implementation of the invention, wherein the aqueous flame retardant composition was applied by deposition onto the non-bonded fiber mat. The excess binder was sucked off and the mat was placed in an oven at 210° C. for 1 minute.

The mat obtained had a mass per unit area of 60 g/m² and contained 20% by weight of infusible binder.

The flame propagation distance and the appearance of the flame are given in Table 1.

The flame propagation distance of Example 1 containing a urea-formaldehyde resin was lower than that in Examples 3 and 4, thus demonstrating a synergistic effect in the presence of a mixture of Mg(OH)₂ and AlOOH.

A higher Mg(OH)₂ and AlOOH content (Example 2) meant that the flame propagation distance was divided by 4.

The flame propagation distance for the mat of Example 5 containing an acrylic resin was much lower than that for Example 7.

The non-colored mat of Example 6 also exhibited a reduction in the flame propagation distance compared with Example 7.

### EXAMPLES 8 TO 11

Aqueous flame retardant compositions containing the constituents shown in Table 2 were prepared in proportions expressed as a % by weight, with the parts by weight being in parentheses. The compositions were prepared under the same conditions as in Examples 1 to 7.

A glass fiber mat was produced, operating the process in accordance with the second implementation of the invention.

Firstly, an E glass fiber mat was produced using the wet procedure: a binder composition containing a urea-formaldehyde resin was applied to the formed mat, the excess of said composition was eliminated and the mat was introduced into an oven at 210° C. for 1 minute.

The mat obtained contained 10% by weight of cured urea-formaldehyde resin and had a mass per unit area equal to 45 g/m².

Secondly, the aqueous flame retardant composition was deposited onto the bound mat of fibers by curtain coating, then it was introduced into an oven at 210° C. for 1 minute.

Finally, the mat had a mass per unit area of 60 g/m² and contained 12.5% by weight of infusible flame retardant composition.

The measurements of the properties of the mats obtained are shown in Table 2.

Example 8 of the invention had better fire resistance than Examples 9 and 10: the flame propagation distance and also the superior calorific value were reduced compared with Examples 9 and 10.

The superior calorific value for Example 8 was lower than Example 11, which contained an identical quantity of phosphorus-containing flame retarding agent.

TABLE 1

| | | | Ex. 3 | Ex. 4 | | | Ex. 7 |
|---|---|---|---|---|---|---|---|
| | Ex. 1 | Ex. 2 | (comp.) | (comp.) | Ex. 5 | Ex. 6 | (comp.) |
| Flame retardant composition | | | | | | | |
| urea-formaldehyde resin⁽¹⁾ | 68.8 (94.50) | 60.8 (83.50) | 68.8 (94.50) | 68.8 (94.50) | — | — | — |
| acrylic resin⁽²⁾ | — | — | — | — | 60.8 (83.50) | 88.0 (88.0) | 72.8 (100.0) |
| Mg(OH)₂ | 2 (2.75) | 6 (8.25) | 4 (5.50) | — | 6 (8.25) | 6 (6) | — |
| AlOOH | 2 (2.75) | 6 (8.25) | — | 4 (5.50) | 6 (8.25) | 6 (6) | — |
| carbon black | 27.2 (37.36) | 27.2 (37.36) | 27.2 (37.36) | 27.2 (37.36) | 27.2 (37.36) | — | 27.2 (37.36) |
| Properties | | | | | | | |
| flame propagation distance | 120 | 30 | >150 | >150 | 20 | 100 | 120 |
| (mm) | | | | | | | |
| appearance of flame | fleeting | fleeting | fleeting | persistent | fleeting | fleeting | fleeting |
| fogging test | | | | | | | |
| visual evaluation | n. d. | n. d. | n. d. | V1/V2 | n. d. | n. d. | n. d. |
| ΔT | n. d. | n. d. | n. d. | 0.0029 (T1) | n. d. | n. d. | n. d. |

n.d.: not determined
⁽¹⁾Marketed under reference Prefere ® 71400 J by the supplier DYNEA
⁽²⁾Marketed under reference Acrodur ® 950L by the supplier BASF

TABLE 2

| | | Ex. 9 | Ex. 10 | Ex. 11 |
|---|---|---|---|---|
| | Ex. 8 | (comp.) | (comp.) | (comp.) |
| Flame retardant composition | | | | |
| acrylic resin⁽²⁾ | 44.6 (86.4) | 44.6 (86.4) | 44.6 (86.4) | 44.6 (100) |
| Mg(OH)₂ | 3.5 (6.8) | 7 (13.6) | — | — |
| AlOOH | 3.5 (6.8) | — | 7 (13.6) | — |
| phosphorus-containing | — | — | — | 7 (15.7) |
| compound⁽³⁾ | | | | |
| carbon black | 24.8 (48.0) | 24.8 (48.0) | 24.8 (48.0) | 24.8 (55.6) |
| CaCO₃ | 23.6 (41.0) | 23.6 (41.0) | 23.6 (41.0) | 23.6 (52.9) |
| Properties | | | | |
| flame propagation distance | 17 | 25 | 21 | 17 |
| (mm) | fleeting | fleeting | fleeting | fleeting |
| appearance of flame | 2.7 | 4.6 | 4.5 | 3.2 |
| SCP | | | | |

⁽¹⁾Marketed under reference Acrodur ® 950L by the supplier BASF
⁽³⁾Marketed under reference Kappaflam ® P31 by the supplier KAPP CHIMIE

1. A mat, comprising:
non-woven mineral fibers; and
an aqueous flame retardant composition, wherein the mineral fibers are treated with the aqueous flame retardant composition, and wherein the aqueous flame retardant composition comprises:
water;
a thermoset resin, wherein the thermoset resin is an acrylic resin selected from the group consisting of a polyvinylidene chloride-acrylic acid resin, an acrylic acid-styrene resin, and a polyacrylic acid resin, a urea-formaldehyde resin, or a mixture thereof;
magnesium hydroxide, Mg(OH)₂, and aluminum hydroxide, AlOOH in a quantity by weight of from 5 to 60% of the total weight of the thermoset resin, the Mg(OH)₂, and the AlOOH; and
optionally, carbon black.

2. The mat of claim 1, wherein the quantity by weight of thermoset resin in the flame retardant composition is from 40% to 95% of the total weight of the thermoset resin, the Mg(OH)₂, and the AlOOH.

3. The mat of claim 1, wherein the proportion by weight of Mg(OH)₂:AlOOH is in the range from 0.3:0.7 to 0.7:0.3.

4. The mat of claim 1, further comprising:
at least one mineral filler selected from the group consisting of calcium carbonate, a clay, talc, and mica.

5. The mat of claim 4, wherein the quantity of mineral filler is up to 30% of the total weight of the thermoset resin, the Mg(OH)₂, and the AlOOH.

6. The mat of claim 1, wherein the carbon black is present and the quantity of carbon black is from 10% to 30% of the total weight of the thermoset resin, the Mg(OH)₂, and the AlOOH.

7. The mat of claim 1, wherein the mat does not comprise carbon black.

8. The mat of claim 1, wherein the non-woven mineral fibers are fibers of glass or rock.

9. The mat of claim 1, wherein the mineral fibers are in the form of filaments, threads composed of a multitude of filaments (base threads), or assemblies of said base threads into rovings.

10. The mat of claim 1, further comprising synthetic or natural organic fibers.

11. The mat of claim 1, having a mass per unit area in the range 10 to 1100 g/m².

12. The mat of claim 1, wherein the flame retardant composition is from 7% to 30% of the weight of the mat, calculated on the basis of the solid materials.

13. The mat of claim 1, wherein the non-woven mineral fibers are formed from glass.

14. The mat of claim 1, wherein the thermoset resin is a urea-formaldehyde resin.

15. The mat of claim 1, wherein the thermoset resin is a polyvinylidene chloride-acrylic acid resin, an acrylic acid-styrene resin, or a polyacrylic acid resin.

16. The mat of claim 1, wherein the proportion by weight of Mg(OH)2:AlOOH is in the range 0.4:0.6 to 0.7:0.3.

17. The mat of claim 1, having a mass per unit area in the range 35 to 75 g/m².
